(19) United States
(12) Patent Application Publication
(10) Pub. No.: US 2025/0352953 A1
(43) Pub. Date: Nov. 20, 2025

(54) FILTER HOLDERS, FILTRATION SYSTEMS, METHODS OF FILTERING A FLUID, AND METHODS OF MANUFACTURING A FILTRATION SYSTEM

(71) Applicant: Chevron U.S.A. Inc., San Ramon, CA (US)

(72) Inventor: James Patrick Meyer, San Rafael, CA (US)

(21) Appl. No.: 18/665,426

(22) Filed: May 15, 2024

(51) Int. Cl. B01D 63/08

(52) U.S. Cl. CPC B01D 63/087; B01D 63/081; B01D 2313/041; B01D 2313/06

(57) ABSTRACT

A filter holder, a filtration system, a method of filtering a fluid, and a method of manufacturing a filtration system are provided. A filter holder includes a filter holder base having an aperture extending therethrough and a cavity formed at a first end thereof. The filter holder base is shaped to receive and support a backing on a first surface thereof and to receive and support a filter membrane on a second surface thereof. The filter holder includes a seal assembly configured to be coupled to the filter holder base and to sealingly engage a surface of the filter membrane when the filter membrane is on the second surface. The filter holder further includes a cover having an aperture formed therethrough and configured to be disposed over the seal assembly and over at least a portion of the filter holder base and secured to the filter holder base.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to filter holders, filtration systems, methods to filter a fluid, and methods of manufacturing a filtration system.

### BACKGROUND

Fluid is oftentimes injected through rock samples (also referred to as core samples) in a lab setting at various pressures, various temperatures, and/or various rates for experiments, studies, etc. Particles may be displaced and carried along within the fluid during these experiments, studies, etc. The fluid has to be filtered to remove those particles. As an example, when working with high pressures, the fluid may be filtered with line filters that use sintered metal filters (also referred to as frits) to remove the particles from the fluid. Unfortunately, these sintered metal filters (frits) tend to be small in diameter (e.g., outer diameter of 12.7 mm) so they have a small surface area to collect particles. At higher pressures, these sintered metal filters (frits) fill up with particles very quickly and typically require frequent replacement, which is labor intensive and expensive.

The ability to analyze rock and fluid properties is crucial to our ability to make the most appropriate choices for purchasing materials, operating safely, and successfully completing projects. Decisions include, but are not limited to, budgetary planning, obtaining mineral and lease rights, signing well commitments, permitting rig locations, designing well paths and drilling strategy, planning proper casing and cementation strategies, selecting and purchasing appropriate completion and production equipment, injection strategy, and production strategy. Therefore, there exists a need in the area of filtering a fluid.

### SUMMARY

In accordance with some embodiments, a filtration system to filter a fluid is disclosed. The filtration system includes: a filter holder base having an aperture extending therethrough and a cavity formed at a first end thereof; a backing disposed in the cavity of the filter holder base; a filter membrane positioned over the backing; a seal assembly coupled to the filter holder base and sealingly engaging a surface of the filter membrane; and a cover having an aperture extending therethrough and disposed over the seal assembly and at least a portion of the filter holder base. The cover is secured to the filter holder base to substantially close the cavity.

In accordance with other embodiments, a filter holder includes a filter holder base having an aperture extending therethrough and a cavity formed at a first end thereof. The filter holder base is shaped to receive and support a backing on a first surface thereof and to receive and support a filter membrane on a second surface thereof. The filter holder also includes a seal assembly configured to be coupled to the filter holder base and to sealingly engage a surface of the filter membrane when the filter membrane is on the second surface of the filter holder base. The filter holder further includes a cover having an aperture formed therethrough and configured to be disposed over the seal assembly and over at least a portion of the filter holder base and secured to the filter holder base to substantially close the cavity.

In accordance with other embodiments, a method of filtering a fluid includes: receiving a fluid into an aperture extending through a cover of a filter holder; filtering the fluid through a filter membrane disposed on a backing located within a cavity of a filter holder base; sealingly engaging a surface of the filter membrane via a seal assembly of the filter holder, wherein the cover is disposed over the seal assembly and at least a portion of the filter holder base, and wherein the cover is secured to the filter holder base to substantially close the cavity; and outputting the filtered fluid through an aperture extending through the filter holder base.

In accordance with other embodiments, a method of manufacturing a filtration system is disclosed. The method includes: providing a filter holder base having an aperture extending therethrough and a cavity formed at a first end thereof; positioning a backing in the cavity of the filter holder base; positioning a filter membrane over the backing in the cavity; coupling a seal assembly to the filter holder base such that the seal assembly sealingly engages a surface of the filter membrane; and securing a cover over at least a portion of the filter holder base and the seal assembly to substantially close the cavity.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles.

FIG. 1A illustrates a side perspective view of a filter holder base in accordance with some embodiments.

FIG. 1B illustrates a top perspective view of the filter holder base of FIG. 1A in accordance with some embodiments.

FIG. 1C illustrates a top perspective view of the filter holder base of FIG. 1A with a backing supported thereon in accordance with some embodiments.

FIG. 1D illustrates a top perspective view of the filter holder base of FIG. 1C with a filter membrane above the backing in accordance with some embodiments.

FIG. 1E illustrates a cross-sectional side view consistent with the filter holder base of FIG. 1A in accordance with some embodiments.

FIG. 1F illustrates a cross-sectional side view (with a closeup shown) consistent with the filter holder base of FIG. 1A with an o-ring compression ring positioned thereon in accordance with some embodiments.

FIG. 1G illustrates a top view of a filter portion of the filter holder base of FIG. 1A with an o-ring compression ring in accordance with some embodiments.

FIG. 2A illustrates a bottom perspective view of a seal assembly for a filtration system in accordance with some embodiments.

FIG. 2B illustrates a top perspective view of an O-ring compression ring consistent with the seal assembly of FIG. 2A in accordance with some embodiments.

FIG. 2C illustrates a bottom perspective view of the O-ring compression ring of FIG. 2B in accordance with some embodiments.

FIG. 2D illustrates a perspective view of an O-ring of the seal assembly of FIG. 2A in accordance with some embodiments.

FIG. 2E illustrates a top perspective view of a filter holder base with the seal assembly of FIG. 2A installed thereon in accordance with some embodiments.

FIG. 2F illustrates a side perspective view of the filter holder base of FIG. 2E with the seal assembly installed thereon in accordance with some embodiments.

FIG. 3A illustrates a side perspective view of a filter holder cover to be placed over a filter holder base in accordance with some embodiments.

FIG. 3B illustrates a top view of the filter holder cover of FIG. 3A in accordance with some embodiments.

FIG. 3C illustrates a side cross-sectional view consistent with the filter holder cover of FIG. 3A in accordance with some embodiments.

FIG. 4 illustrates a filtration system to filter a fluid that includes at least one filter assembly in accordance with some embodiments.

FIG. 5 illustrates a flowchart of a method of filtering a fluid in accordance with some embodiments.

FIG. 6 illustrates a flowchart of a method of manufacturing a filtration system in accordance with some embodiments.

Like reference numerals refer to corresponding parts throughout the drawings

### DETAILED DESCRIPTION OF THE DRAWINGS

The example embodiments discussed herein are directed to a filter holder, a filtration system that includes a filter holder, a method of filtering a fluid through a filtration system that includes a filter holder, and a method of manufacturing a filtration system that includes a filter holder.

In some embodiments, the filter holder includes a filter holder base that is shaped to receive and support a backing on a first surface thereof and to receive and support a filter membrane on a second surface thereof. Advantageously, a sintered metal filter (frit) may be utilized as the backing for the filter membrane within the filter holder, which allows for a larger filtration surface area to be used to collect particles and allows for a larger volume of fluid to pass through the filter membrane before replacement of the filter membrane. Advantageously, it may be more economical to replace lower cost filter membranes (e.g., cellulose acetate filter membranes) frequently than to replace higher cost sintered metal filters (frits) frequently. Advantageously, it may also be less labor intensive and less disruptive to operations to replace lower cost filter membranes (e.g., cellulose acetate filter membranes) less frequently than to replace higher cost sintered metal filters (frits) more frequently. The filter membranes that may be used with the disclosed filter holder may have a standard filter size such as, for example, 47 mm in diameter, making them cheaper and easier to replace than specially sized sintered metal filters (frits).

The filter holder includes three parts in some embodiments: (a) a filter holder base that is the male side of the filter holder, (b) a seal assembly, and (c) a filter holder cover (referred to herein as the “cover”) that is the female side of the filter holder. The filter holder base may allow a backing (e.g., a sintered metal filter) to be inserted above the flow path in the center of the filter holder base. The backing (e.g., sintered metal filter) is also used as a backing for the filter membrane, as the filter membrane may be placed directly above the sintered metal filter. The seal assembly may provide a seal (e.g., an O-ring) that engages a surface of the filter membrane to reduce (or even prevent in some embodiments) any movement (e.g., twisting) of the filter membrane with respect to the backing and direct fluid entering the filter system through the filter membrane.

In some embodiments, the seal assembly may include an O-ring and an O-ring compression ring. The O-ring compression ring may place the O-ring above the filter membrane and compress the O-ring down against the filter membrane. In addition, the O-ring compression ring may interlock with the filter holder base. Advantageously, the O-ring compression ring may reduce (or even prevent in some embodiments) any movement (e.g., twisting) of the O-ring with respect to the filter membrane during the filter assembly process. Moreover, advantageously, the O-ring compression ring may reduce (or even prevent in some embodiments) any movement (e.g., twisting) of the O-ring with respect to the filter membrane during filtration of the fluid.

The cover may be coupled (e.g., threaded) onto the filter holder base with the seal assembly (e.g., until the threads bottom out), which may compress the seal (e.g., O-ring) of the seal assembly into place against the filter membrane. Advantageously, the compression of the seal ensures less to no bypass of particles around the filter membrane. Furthermore, the filter holder base, the cover, and/or portions of the seal assembly may be made of metal, such as titanium, to handle a variety of pressures, a variety of temperatures, a variety of fluids, etc. The metal portions of the filter holder may be fabricated out of 6AL-4V Titanium (Grade 5), which is a titanium alloy with corrosion resistant properties. Advantageously, the filter holder allows for the filtration of fluid using the filter membrane above (i.e., upstream of) the backing at a pressure up to 30,000 psi and/or temperature of from ambient to 300° F.

Some embodiments of the filter holder may allow for the filtration of fluid at fluid pressures of 30,000 psi or less (e.g., 27,500 psi or less, 25,000 psi or less, 22,500 psi or less, 20,000 psi or less, 17,500 psi or less, 15,000 psi or less, 12,500 psi or less, 10,000 psi or less, 7,500 psi or less, 5,000 psi or less, 2,500 psi or less, 2,000 psi or less, 1,500 psi or less, 1,000 psi or less, 500 psi or less, 250 psi or less, 100 psi or less, 50 psi or less, 25 psi or less, or 10 psi or less). Some embodiments may allow for the filtration of fluid at a pressure of 1 psi or higher (e.g., 10 psi or higher, 25 psi or higher, 50 psi or higher, 100 psi or higher, 250 psi or higher, 500 psi or higher, 1,000 psi or higher, 1,500 psi or higher, 2,000 psi or higher, 2,500 psi or higher, 5,000 psi or higher, 7,500 psi or higher, 10,000 psi or higher, 12,500 psi or higher, 15,000 psi or higher, 17,500 psi or higher, 20,000 psi or higher, 22,500 or higher, 25,000 psi or higher, or 27,500 psi or higher). Some embodiments may allow for the filtration of fluid at a pressure ranging from any of the minimum values described above to any of the maximum values described above. For example, some embodiments may allow for the filtration of fluid at a pressure of from 1 psi to 30,000 psi (e.g., from 1 psi to 15,000 psi, from 1 psi to 20,000 psi, from 15,000 psi to 30,000 psi, from 20,000 psi to 30,000 psi, or from 25,000 psi to 30,000 psi). As indicated above, some embodiments may allow for the filtration of fluid at a pressure of from positive psi (not vacuum) to 30,000 psi.

Some embodiments of the filter holder may allow for the filtration of fluid having a temperature of 300° F. or less (e.g., 290° F. or less, 280° F. or less, 270° F. or less, 260° F. or less, 250° F. or less, 240° F. or less, 230° F. or less, 220° F. or less, 210° F. or less, 200° F. or less, 190° F. or less, 180° F. or less, 170° F. or less, 160° F. or less, 150° F. or less, 140° F. or less, 130° F. or less, 120° F. or less, 110° F. or less, 100° F. or less, 90° F. or less, 80° F. or less, 75° F. or less, 70° F. or less, or 65° F. or less). Some embodiments may allow for the filtration of fluid having a temperature of 60° F. or higher (e.g., 65° F. or higher, 70° F. or higher, 75° F. or higher, 80° F. or higher, 90° F. or higher, 100° F. or higher, 110° F. or higher, 120° F. or higher, 130° F. or higher, 140° F. or higher, 150° F. or higher, 160° F. or higher, 170° F. or higher, 180° F. or higher, 190° F. or higher, 200° F. or higher, 210° F. or higher, 220° F. or higher, 230° F. or higher, 240° F. or higher, 250° F. or higher, 260° F. or higher, 270° F. or higher, 280° F. or higher, or 290° F. or higher). Some embodiments may allow for the filtration of fluid having a temperature ranging from any of the minimum values described above to any of the maximum values described above. For example, some embodiments may allow for the filtration of fluid having a temperature of from 60° F. to 300° F. (e.g., from 65° F. to 300° F., from 70° F. to 300° F., from 75° F. to 300° F., from 80° F. to 300° F., from 100° F. to 300° F., from 150° F. to 300° F., from 200° F. to 300° F., or from 150° F. to 250° F.). As indicated above, some embodiments may use a temperature of from ambient to 300° F.

The fluid to be filtered through a filtration system having the filter holder may include practically any type of water, treated or untreated, and can vary in salt content. For example, the fluid to be filtered may include sea water, brackish water, flowback or produced water, wastewater (e.g., reclaimed or recycled), brine (e.g., reservoir brine or synthetic brine), fresh water (e.g., fresh water comprises <1,000 ppm TDS water), mineral oil, hydrocarbon (e.g., residual hydrocarbon), or any combination thereof. The fluid to be filtered may include a liquid phase, gas phase, and/or solid phase. In one embodiment, the fluid to be filtered may include mineral oil. In one embodiment, the fluid to be filtered may include reservoir brine and residual hydrocarbon. In one embodiment, the fluid to be filtered may be a simulated reservoir fluid.

The fluid that is filtered through a filtration system having the filter holder may be produced from a wellbore. The fluid that is filtered may be injected into a wellbore. The fluid that is filtered may be utilized in experiments, studies, etc. A “wellbore” may be a cylindrical hole drilled into the formation such that the wellbore is surrounded by the formation. In some implementations, a wellbore may be used for injection. In some implementations, a wellbore may be used for production. The wellbore may have vertical, inclined, horizontal, or any combination of trajectories depending on the implementation. For example, the wellbore may be a vertical wellbore, a horizontal wellbore, a multilateral wellbore, or slanted wellbore depending on the implementation. The wellbore may include a plurality of components, such as, but not limited to, a casing, a liner, a tubing string, a sensor, a packer, etc. The wellbore may also include equipment to control fluid flow into the wellbore, control fluid flow out of the wellbore, or any combination thereof. For example, each wellbore may include a wellhead, chokes, valves, or other control devices. These control devices may be located on the surface, in the subsurface (e.g., downhole in the wellbore), or any combination thereof. The wellbore may also include at least one artificial lift device, such as, but not limited to, an electrical submersible pump (ESP) or gas lift. The term wellbore is not limited to any description or configuration described herein. The term wellbore may be used synonymously with the term borehole or the term well.

In some embodiments, the fluid that is filtered through a filtration system having the filter holder may be produced from and/or injected into a wellbore drilled into a conventional formation. Alternatively, the fluid that is filtered may be produced from and/or injected into a wellbore drilled into an unconventional formation (e.g., shale and tight), which may have a permeability in nano to millidarcies. In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD). The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD).

To facilitate understanding of the disclosure set forth herein, a number of terms are defined herein. Unless defined otherwise, all technical and scientific terms used herein can have the same meaning as commonly understood by one of ordinary skill in the art to which this disclosure belongs. Unless otherwise specified, all percentages are in weight percent and the pressure is in atmospheres. All citations referred to herein are expressly incorporated by reference.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The use of the term “about” applies to all numeric values, whether or not explicitly indicated. This term can refer to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Terms such as “first”, “second”, “primary,” “secondary,” “above”, “below”, “inner”, “outer”, “distal”, “proximal”, “end”, “down”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

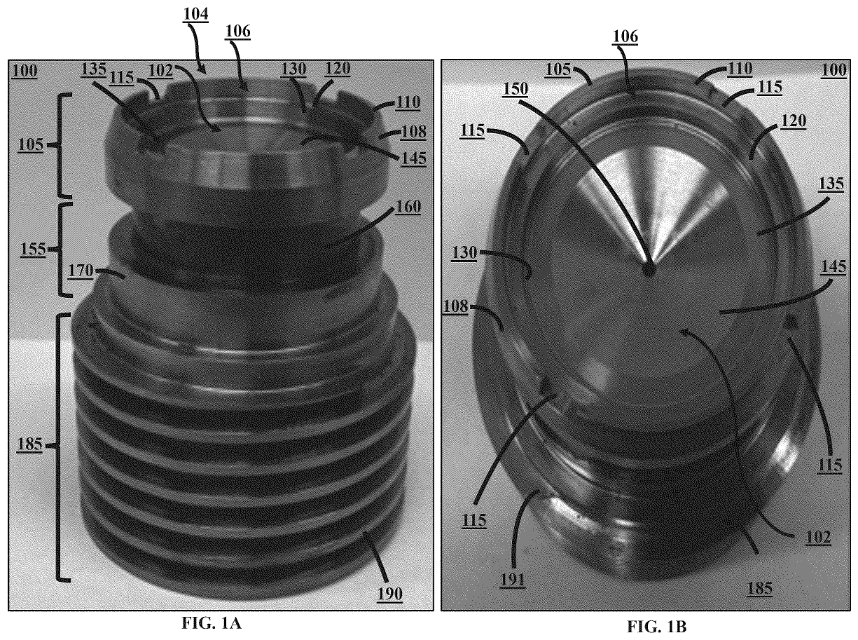

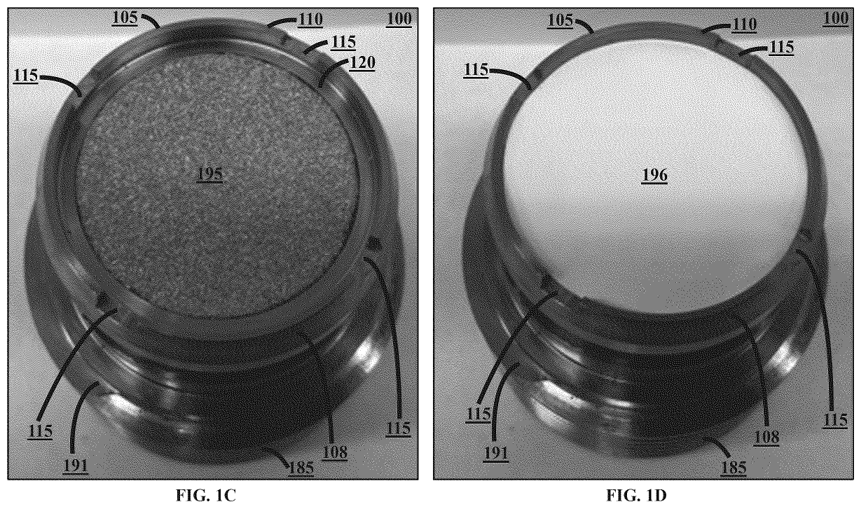

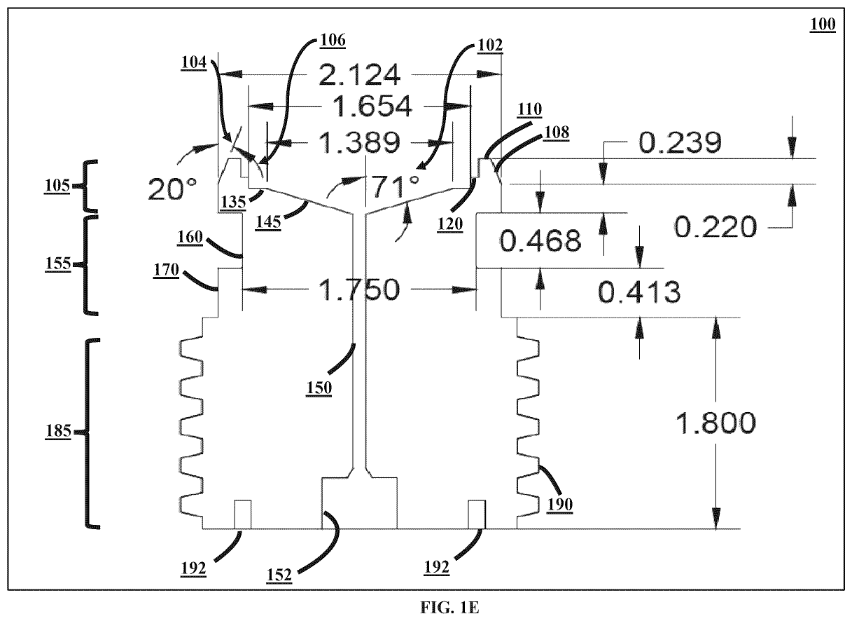

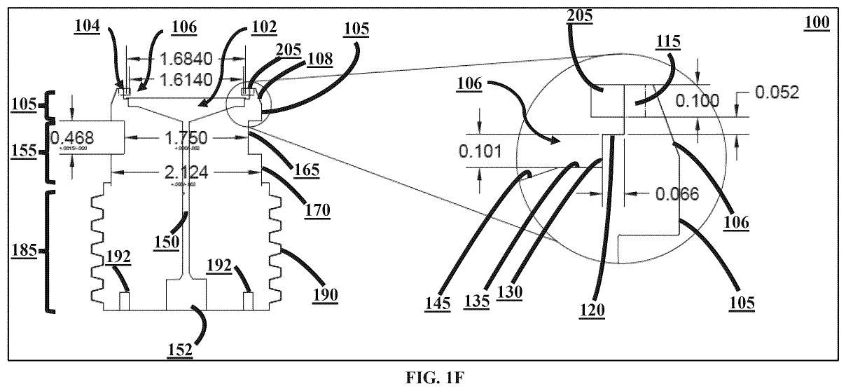

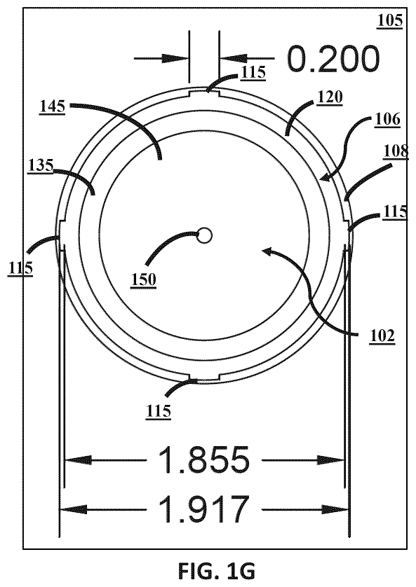

Turning now to the drawings, FIGS. 1A-1G illustrate a filter holder base 100 in accordance with some embodiments. FIGS. 1C and 1D show the filter holder base 100 with a backing 195 and a filter membrane 196, respectively, placed thereon. FIG. 1F shows the filter holder base 100 with an O-ring compression ring 205 positioned thereon. FIG. 1G shows a top view of a filter portion 105 of the filter holder base 100 without showing the rest of the filter holder base.

With reference to FIGS. 1A-1G, the filter holder base 100 has an aperture 150 extending therethrough and a cavity 102 formed at a first end (e.g., upper end) 104 thereof. The filter holder base 100 is shaped to receive and support the backing 195 on a first surface (e.g., backing support surface) 135 thereof and to receive and support the filter membrane 196 on a second surface (e.g., filter support surface) 120 thereof. As illustrated more clearly in FIG. 1E, at least a portion of the cavity 102 of the filter holder base 100 may be defined by a stepped profile 106 along an inner diameter of the filter holder base 100, with the first surface 135 and the second surface 120 being different upward facing surfaces of the stepped profile 106. The second surface 120 is located above (i.e., closer to the first end 104 of the filter holder base 100) than the first surface 135, as shown. The cavity 102 in the filter holder base 100 may also have a funnel shaped portion 145 located below (i.e., further from the first end 104 of the filter holder base 100 than) the stepped profile 106. The funnel shaped portion 145 may generally narrow from the stepped profile 106 to the aperture 150.

The filter holder base 100 may have a total height from about 50 mm to about 240 mm. In some embodiments, the filter holder base 100 may have a total height from about 65 mm to about 220 mm. In some embodiments, the filter holder base 100 may have a total height from about 80 mm to about 150 mm. In the illustrated embodiment, the filter holder base 100 has a total height of about 80 mm. The filter holder base 100 may have a maximum outer diameter from about 40 mm to about 220 mm. In some embodiments, the filter holder base 100 may have a maximum outer diameter from about 55 mm to about 205 mm. In some embodiments, the filter holder base 100 may have a maximum outer diameter from about 70 mm to about 135 mm. In the illustrated embodiment, the filter holder base 100 has a maximum outer diameter of about 70 mm. It should be noted that other sizes (e.g., height, maximum outer diameter, etc.) may be used for the filter holder base 100 in other embodiments.

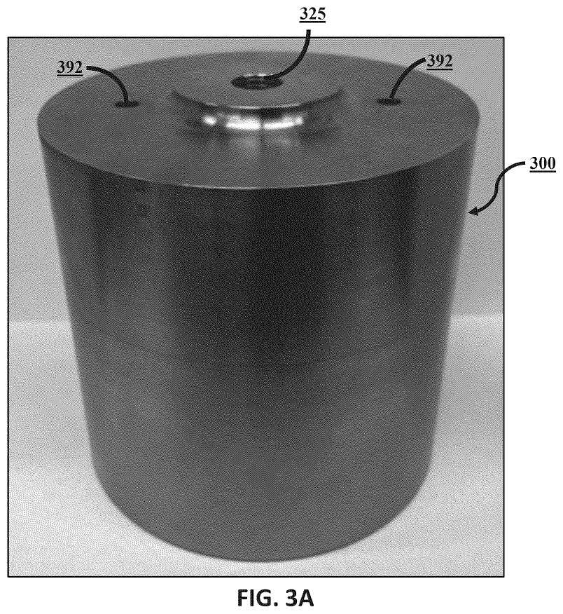

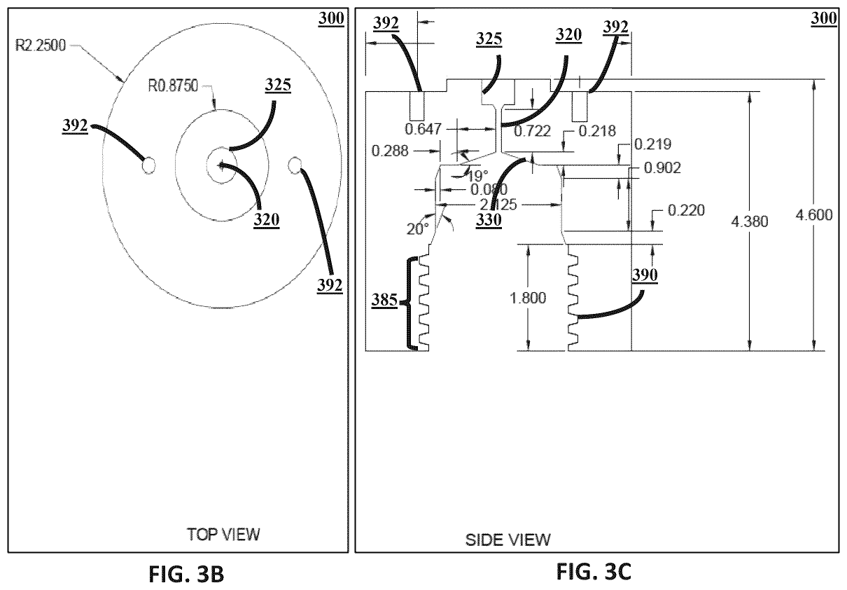

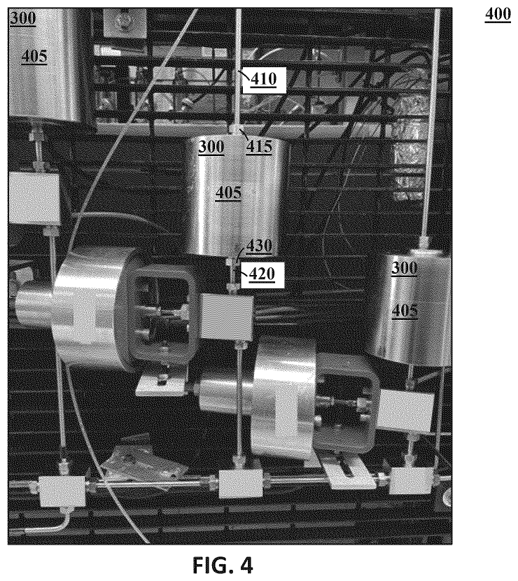

As illustrated, the filter holder base 100 may have a filter portion 105, a sealing portion 155 adjacent to the filter portion 105, and a threaded portion 185 adjacent to the sealing portion 155. A filter holder cover (e.g., cover 300, as shown in FIGS. 3A-3C) may be coupled to the filter holder base 100 to assemble a filter assembly (e.g., 405 of FIG. 4) to filter a fluid. The filter holder base 100 and the cover 300 may be fabricated out of 6AL-4V Titanium (Grade 5), which is a titanium alloy with corrosion resistant properties.

The filter portion 105 of the filter holder base 100 may include the backing support surface 135 for supporting the backing 195. As illustrated, the backing support surface 135 may be an upward facing, annular shaped surface extending radially inward from a radially inner surface 130 of the filter holder base 100. The backing 195 may be a disc shaped backing. The backing 195 may have a diameter from about 25 mm to about 135 mm. For example, the backing may be about 41 mm in diameter. The backing 195 may be between about 1.0 mm and about 5.0 mm thick. For example, the backing may be about 2.54 mm thick. However, it should be noted that other sizes (e.g., diameter or thickness) may be used for the backing 195 in other embodiments. The backing 195 may be a metal filter (or frit) in an embodiment. For example, the backing 195 may be a sintered Hastelloy C276 disc. However, it should be noted that other types of materials may be used for the backing 195 in other embodiments. In the drawings, the backing support surface 135 may support the backing 195, as illustrated in FIG. 1C. The backing support surface 135 may be substantially horizontal and may support at least a portion of the weight of the backing 195. The backing support surface 135 may form a 90 degree angle with respect to a vertical, radially inner surface 130 of the filter portion 105. When the backing 195 is disposed within the filter holder base 100, as shown in FIG. 1C, the backing 195 may be supported directly on the backing support surface 135 and/or other portion(s) of the filter holder base 100.

The backing support surface 135, when viewed from a direction perpendicular to the backing support surface 135, may have an outer diameter from about 30 mm to about 140 mm and an inner diameter from about 25 mm to about 130 mm, with the outer diameter being larger than the inner diameter. In some embodiments, the backing support surface 135 may have an outer diameter from about 35 mm to about 120 mm and an inner diameter from about 30 mm to about 100 mm, with the outer diameter being larger than the inner diameter. In some embodiments, the backing support surface may have an outer diameter from about 42 mm to about 80 mm and an inner diameter from about 35 mm to about 72 mm, with the outer diameter being larger than the inner diameter. In the illustrated embodiment, the backing support surface 135 has an outer diameter of about 42 mm and an inner diameter of about 35.3 mm.

The filter portion 105 may include the filter support surface 120 for supporting the filter membrane 196. As illustrated, the filter support surface 120 may be an upward facing, annular shaped surface extending radially inward from a seal support portion 110. The filter membrane 196 may be a disc shaped membrane. The filter membrane 196 may be from about 40 mm to about 150 mm in diameter. The filter membrane may have a standard filter membrane diameter such as, for example, 37 mm, 47 mm, 90 mm, or 142 mm, among others. In one embodiment, for example, the filter membrane 196 may be approximately 47 mm in diameter. However, it should be noted that other sizes may be used for the filter membrane 196 in other embodiments. The filter membrane 196 may be a cellulose acetate membrane in an embodiment. However, it should be noted that other types of materials may be used for the filter membrane 196 in other embodiments. Depending on the pore fluid and desired filtration pore size, silver membranes, ceramic membranes, and glass fiber filters may be used for the filter membrane. As shown in FIG. 1D, the filter support surface 120 may support the filter membrane 196. The filter support surface 120 may be substantially horizontal and may support at least a portion of the weight of the filter membrane 196. The filter support surface 120 may form a 90 degree angle with respect to a vertical, radially inner surface of a seal support portion 110 of the filter holder base 100.

The filter support surface 120, when viewed from a direction perpendicular to the filter support surface 120, may have an outer diameter from about 35 mm to about 143 mm and an inner diameter from about 30 mm to about 135 mm, with the outer diameter being larger than the inner diameter. The filter support surface 120 may have an outer diameter from about 40 mm to about 138 mm and an inner diameter from about 35 mm to about 130 mm, with the outer diameter being larger than the inner diameter. The filter support surface 120 may have an outer diameter from about 48 mm to about 91 mm and an inner diameter from about 42 mm to about 85 mm, with the outer diameter being larger than the inner diameter. In the illustrated embodiment, the filter support surface 120 has an outer diameter of about 48 mm and an inner diameter of about 42 mm.

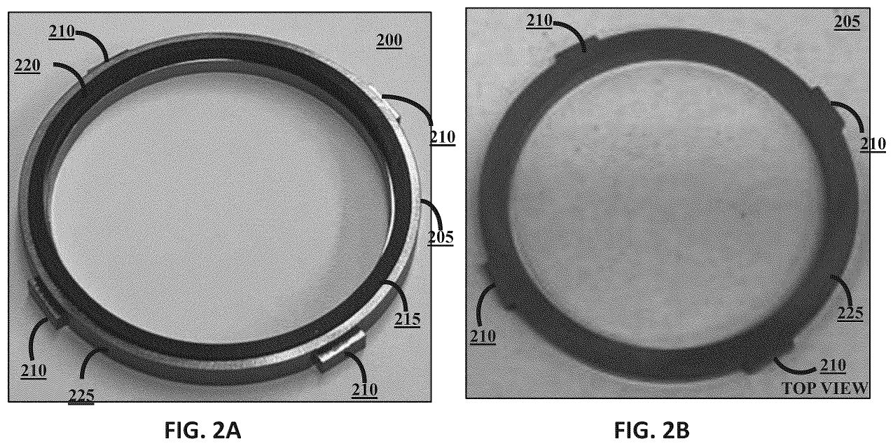

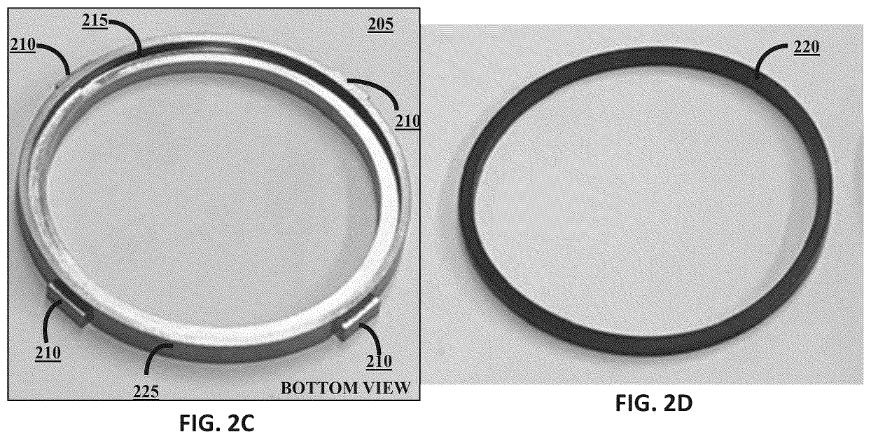

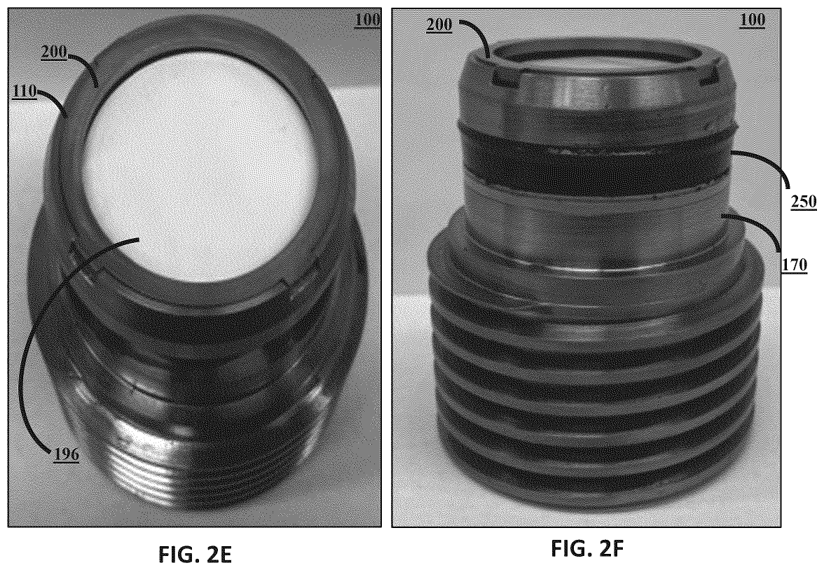

When the filter membrane 196 is placed within the filter holder base, as shown in FIG. 1D, the filter membrane 196 is supported directly by the backing 195 and the filter support surface 120. Since the more easily replaceable filter membrane 196 is positioned atop the backing 195, the filter membrane 196 will capture any solid material from the fluid flowing therethrough, and the filtered fluid will continue through the backing 195. As such, there is generally no need to change out the backing 195, which is more expensive than the filter membrane 196. Instead, the less expensive filter membrane 196 may be periodically replaced when the filter becomes clogged, thus reducing operational costs. When the filter assembly is fully assembled, the filter membrane 196 may be disposed between the filter support surface 120 on one (lower) side of the filter membrane 196 and the seal assembly (e.g., 200 of FIG. 2A) on an opposite (upper) side of the filter membrane 196.

The filter portion 105 of the filter holder base 100 may include the seal support portion 110 at an upper end 104 of the filter holder base 100. A seal assembly (e.g., seal assembly 200 of FIG. 2A) may be located radially inside of and/or partially atop the seal support portion 110 upon assembly of the filter assembly (e.g., 405 of FIG. 4). As described further below, the seal assembly (200) is configured to be coupled to the filter holder base 100 and to sealingly engage a surface of the filter membrane 196 when the filter membrane 196 is on the filter support surface 120 of the filter holder base 100. During operation, the seal support portion 110 may help to reduce movement of the seal assembly (200) and therefore reduce the probability that the seal assembly will damage a filter membrane 196 located below the seal assembly. As illustrated, the seal support portion 110 may include one or more keying features (e.g., grooves) 115 formed therein. These may receive corresponding keying features (e.g., protrusions) from the seal assembly (200) when the seal assembly is placed in the filter holder base 100.

The backing support surface 135, the radially inner surface 130, the filter support surface 120, and the radially inner surface of the seal support portion 110 together may form the stepped profile 106 defining at least a portion of the cavity 102 at the upper end of the filter holder base 100. The filter portion 105 may also include a tapered outer edge 108 at an upper end 104 of the filter holder base 100 to facilitate placement of a seal onto the sealing portion 155 of the filter holder base 100.

Turning to FIG. 1E, the funnel shaped portion 145 of the filter holder base 100 may taper toward the aperture 150 that extends the length of the filter holder base 100. An angle of the funnel shaped portion 145 of the filter holder base 100 with respect to a horizontal plane may be between about 5 degrees and about 45 degrees. In the illustrated embodiment, the angle of the funnel shaped portion 145 of the filter holder base 100 with respect to the horizontal plane is about 19 degrees. The aperture 150 is fluidly coupled to an outlet 152. During operation, fluid that enters the filter holder base 100 may flow through the filter membrane 196, then through the backing 195, then through the funnel shaped portion 145, then through the aperture 150, and then through the outlet 152 to exit the filter holder base 100. The outlet 152 at the lower end of the aperture 150 may be configured to receive a fluid coupler.

The sealing portion 155 of the filter holder base 100 may be located adjacent to (e.g., vertically below) the filter portion 105. The sealing portion 155 of the filter holder base 100 may include a seal groove 160 for supporting a seal (e.g., seal 250 in FIG. 2F). The sealing portion 155 may include a seal support 170 for further supporting the seal (250) from below. The seal support 170 is adjacent to and partially defines the seal groove 160 and it may support at least a portion of the weight of the seal (250). The seal (250) may thus be generally located within the seal groove 160 and between the filter portion 105 and the seal support 170. The depth and width of the seal groove 160 may be selected using the Parker Fluid Power Seal Design Guide Catalog EPS 5370.

The threaded portion 185 may be used to couple the filter holder base 100 with the cover (e.g., cover 300 of FIGS. 3A-3C) to assemble a filter assembly (e.g., filter assembly 405 of FIG. 4) used to filter the fluid. Specifically, the threaded portion 185 of the filter holder base 100 couples with a corresponding threaded portion 385 of the cover 300 in FIGS. 3A-3C to assemble the filter assembly 405 in FIG. 4. The threaded portion 185 includes at least one thread 190, and each thread 190 may be tapered on both sides. The one or more threads 190 may interface with a corresponding one or more internal threads of the cover (300). The topmost thread 190 of the threaded portion 185 may be shortened, as illustrated at location 191 in FIGS. 1B, 1C, and 1D, to facilitate coupling of the cover (300) to the filter holder base 100. The threaded portion 185 of the filter holder base 100 may have a height from about 25 mm to about 135 mm. In some embodiments, the threaded portion 185 may have a height from about 35 mm to about 125 mm. In some embodiments, the threaded portion 185 may have a height from about 45 mm to about 85 mm. In the illustrated embodiment, the threaded portion 185 has a height of about 46 mm.

Although in the illustrated embodiment the filter holder base 100 includes the threaded portion 185 for coupling the cover (300) to the filter holder base 100, in other embodiments the filter holder base 100 may include another type of coupling feature (e.g., threaded apertures to receive bolts, etc.) enabling the cover (300) to be coupled to the filter holder base 100. Regardless of the coupling mechanism used, the cover (300) is configured to be disposed over at least a portion of the filter holder base 100 and secured to the filter holder base 100 to substantially close the cavity 102 of the filter holder base 100.

The filter holder base 100 may also include at least one opening 192 to receive a tool to couple the filter holder base 100 and the cover (300). Each opening 192 may be a spanner hole, such as a 4¼ inch spanner hole, that is machined into the filter holder base 100. Each opening 192 may extend only partially through the filter holder base 100. Two substantially similar openings 192 are illustrated in FIG. 1F, but the openings may vary depending on the tool or tools that may be utilized on the filter holder base 100. Examples of the tool to be used with the filter holder base 100 include, but are not limited to, a spanner wrench. As mentioned above, the filter holder base 100 forms the male side of a filter holder. It is considered the male side of the filter holder because the male side of the general acme threads (e.g., 2.75×4) is machined along the outside of the part.

FIGS. 2A-2D illustrate an embodiment of the seal assembly 200 and its constituent parts. FIGS. 2E and 2F illustrate the seal assembly 200 installed on the filter holder base 100 along with the backing (not visible) and the filter membrane 196. In this installed position, the seal assembly 200 is coupled to the filter holder base 100 to sealingly engage a surface (i.e., the upper surface) of the filter membrane 196 when the filter membrane 196 is installed (e.g., on the filter support surface and the backing) in the filter holder base 100.

As shown in FIG. 2A, the seal assembly 200 may include an O-ring 220 to provide a seal within the filtration assembly. The O-ring 220 is illustrated without the rest of the seal assembly 200 in FIG. 2D. The O-ring 220 may be used to sealingly engage the upper surface of the filter membrane 196 when the seal assembly 200 is installed on the filter holder base 100, as shown in FIG. 2E. The seal assembly 200 may also include an O-ring compression ring 205. The O-ring compression ring 205 is illustrated without the O-ring in FIGS. 2B and 2C. As shown in FIG. 2C, an O-ring holder cavity 215 is formed in a main body 225 of the O-ring compression ring 205. As such, the O-ring compression ring 205 may support the O-ring 220 within the O-ring holder cavity 215. In the illustrated embodiment, the O-ring compression ring 205 has a substantially circular shaped body 225 with four projections 210 extending therefrom. The O-ring compression ring 205 may be fabricated out of 6AL-4V Titanium (Grade 5), which is a titanium alloy with corrosion resistance.

The O-ring compression ring 205 may be shaped to form an interlocking interface with the filter holder base (e.g., 100 of FIG. 1A). For example, the O-ring compression ring 205 may include one or more projections 210 configured to be received into one or more grooves at the first end (e.g., 104 of FIG. 1A) of the filter holder base (e.g., 100). FIG. 1F provides a cross-sectional view of the O-ring compression ring 205 being located and supported within the keying features (e.g., grooves) 115 of the filter holder base 100. In the illustrated embodiment of FIGS. 2A-2C, the O-ring compression ring 205 includes four projections 210 spaced equidistantly around the circumference of the ring. The projections 210 may extend from about 1 mm to about 5 mm from the main body 225 of the O-ring compression ring 205. In the illustrated embodiment, the projections 210 extend about 1.5 mm out from the body 225 of the O-ring compression ring 205. In other embodiments, other types of interlocking shapes may be used to connect the O-ring compression ring 205 to the end of the filter holder base (100). For example, the O-ring compression ring 205 may include grooves into which corresponding projections of the filter holder base (100) may be received. The interlocking interface between the O-ring compression ring 205 and the filter holder base (100) may be used to reduce or, in some cases, eliminate, rotation of the O-ring compression ring 205 and the O-ring 220 carried therein with respect to the filter holder base (100).

During assembly of a filtration system in accordance with present embodiments, an O-ring 220 may first be positioned within the cavity 215 of the O-ring compression ring 205 to form the seal assembly 200. The seal assembly 200 may then be placed on top of the filter membrane 196 with the keying features (e.g., projections 210) of the seal assembly 200 interfacing with the complementary keying features (e.g., grooves) of the filter holder base 100, as shown in FIG. 2E. At this point, the O-ring compression ring 205 compresses the O-ring 220 of the seal assembly 200 against the filter membrane 196. At the same time, the projection(s) 210 of the O-ring compression ring 205 restrict rotation of the seal assembly 200 with respect to the filter membrane 196 and/or the filter holder base 100. This secures the O-ring 220 and the filter membrane 196 in place with respect to the filter holder base 100 throughout the rest of the assembly process (e.g., rotating the cover 300 of FIGS. 3A-3C onto the filter holder base 100). Once installed, the seal assembly 200 may seal the area around the filter membrane 196 so that the majority or all of the fluid flows through the filter membrane 196. In addition, the installed seal assembly 200 may increase the probability that the O-ring 220 and the filter membrane 196 will remain substantially in place during operations.

FIG. 2F illustrates a filter assembly without the cover (e.g., 300 of FIGS. 3A-3C) installed. As shown, the filter assembly includes a seal 250 positioned around the outer circumference of the filter holder base 100. This seal 250 may be received in the seal groove (e.g., 160 of FIGS. 1A-1F) of the filter holder base 100. The seal 250 is used to fluidically seal an annulus between the filter holder base 100 and the cover (e.g., 300 of FIGS. 3A-3C) once the cover is installed on the filter holder base 100. The seal 250 may be a Parker Polypak Type B seal (e.g., with PEEK backup rings) in one embodiment. For example, the size of the seal 250 may be selected from the Parker Fluid Power Seal Design Guide Catalog EPS 5370 in one embodiment. However, other types, sizes, and materials may be used for the seal 250 in other embodiments. The seal 250 may be capable of sealing against fluid at pressures up to 30,000 psi, sealing against fluid at temperatures up to 300 degrees Fahrenheit, or both.

FIGS. 3A-3C illustrate a filter holder cover (“cover”) 300 in accordance with an embodiment. The cover 300 is configured to be disposed over the seal assembly (e.g., 200 of FIGS. 2A, 2E, and 2F) and over at least a portion of the filter holder base (e.g., 100 of FIG. 1A) and secured to the filter holder base (100) to substantially close the cavity (e.g., 102 of FIG. 1A) of the filter holder base (100). In some embodiments, the cover 300 may substantially cover or fully cover the filter holder base (100).

The cover 300 may have a total height from about 70 mm to about 350 mm. In some embodiments, the cover 300 may have a total height from about 95 mm to about 320 mm. In some embodiments, the cover 300 may have a total height from about 110 mm to about 220 mm. In the illustrated embodiment, the cover 300 has a total height of about 117 mm. The cover 300 may have a maximum outer diameter from about 60 mm to about 350 mm. In some embodiments, the cover 300 may have a maximum outer diameter from about 85 mm to about 300 mm. In some embodiments, the cover 300 may have a maximum outer diameter from about 110 mm to about 210 mm. In the illustrated embodiment, the cover 300 has a maximum outer diameter of about 114 mm. However, other sizes (e.g., height, maximum outer diameter, etc.) may be used for the cover 300 in other embodiments.

The cover 300 may have a generally cylindrical shape, as shown. The cover 300 includes an aperture 320 formed therethrough. This aperture 320 enables fluid to flow through the cover 300 and onto the filter membrane (e.g., 196 of FIG. 2F) of the filter assembly. The aperture 320 is fluidly coupled to an inlet 325 at its upper end. The inlet 325 at the upper end of the aperture 320 may be configured to receive a fluid coupler. The aperture 320 at its lower end may open up to an upside-down funnel shaped portion 330. The upside-down funnel shaped portion 330 of the cover 300 may taper away from the aperture 320 that extends through the cover 300. An angle of the upside-down funnel shaped portion 330 of the cover 300 with respect to a horizontal plane may be between about 5 degrees and about 45 degrees. In the illustrated embodiment, the angle of the upside-down funnel shaped portion 330 of the cover 300 with respect to the horizontal plane is about 19 degrees. During operation, fluid may enter the cover 300 through the inlet 325 and flow through the aperture 320, then through the upside-down funnel shaped portion 330 to enter the filter membrane (196) held in the filter holder base (100). The upside-down funnel shaped portion 330 may direct fluid to flow across an entire filtration surface of the filter membrane (196) within the filter assembly.

The cover 300 may include a threaded portion 385 along an inner circumference thereof toward the bottom end of the cover 300. The threaded portion 385 may be used to couple the cover 300 with the filter holder base (e.g., 100 of FIG. 1A) to assemble the filter assembly (e.g., 405 of FIG. 4) used to filter the fluid. Specifically, the threaded portion 385 of the cover 300 couples with the corresponding threaded portion 185 of the filter holder base 100 in FIG. 1A to assemble the filter assembly 405 in FIG. 4. The threaded portion 385 includes at least one internal thread 390, and each thread 390 may be tapered on both sides. The one or more threads 390 may interface with a corresponding one or more external threads of the filter holder base (100). The topmost internal thread 390 of the threaded portion 385 may be shortened to facilitate coupling of the cover 300 to the filter holder base (100). A height of the threaded portion 385 of the cover 300 may be equivalent to the height of the threaded portion (185) of the mating filter holder base (100).

The inner surface(s) of the cover 300 may be shaped to fit snugly over the fully assembled filter holder base 100, filter membrane 196, and seal assembly 200 shown in FIG. 2F. For example, the cover 300 may include an internal tapered edge that matches the tapered outer edge (e.g., 108 of FIG. 1A) at the upper end of the filter holder base. A radially inner surface of the cover 300 may engage the seal (e.g., 250 of FIG. 2F) around the filter holder base (100).

Similar to the filter holder base (e.g., 100 of FIG. 1A), the cover 300 may include at least one opening 392 to receive a tool to couple the cover 300 to the filter holder base (100). Each opening 392 may be a spanner hole, such as a 4¼ inch spanner hole, that is machined into the cover 300. Two substantially similar openings 392 are illustrated in FIGS. 3A-3C, but the openings may vary depending on the tool or tools that may be utilized on the cover 300. Examples of the tool to be used with the cover 300 include, but are not limited to, a spanner wrench.

As mentioned above, the cover 300 forms the female side of the filter holder. It is considered the female side of the filter holder because the female side of the general acme threads (e.g., 2.75×4) is machined along the inside of the part.

Fully assembling a filter assembly (e.g., 405 of FIG. 4) from the filter holder base 100 of FIGS. 1A-1F, the seal assembly 200 of FIGS. 2A-2F, and the cover 300 of FIGS. 3A-3C involves the following. Once the seal 250 and the seal assembly 200 are positioned onto the filter holder base 100, as described with reference to FIG. 2F, the cover 300 may be coupled to the filter holder base 100. For example, the cover 300 may be lowered onto the filter holder base 100 with the seal assembly 200, and then the cover and/or the filter holder base 100 is rotated to make up their threads. When the threads bottom out, an upper portion of the cover 300 applies a downward force onto the seal assembly 200, thus causing the O-ring compression ring (e.g., 205) to compress the O-ring (e.g., 220) against the filter membrane 196. This forms a seal between the seal assembly 200 and the filter membrane 196, ensuring no particles can bypass the filter membrane.

FIG. 4 illustrates a filtration system 400 that may be used to filter a fluid. The filtration system 400 may be particularly useful for filtering high pressure and/or high temperature fluids. For example, the filtration system 400 may be capable of filtering the fluid at a fluid pressure within a range of about 1 psi to about 30,000 psi, at a fluid temperature within a range of about 60 degrees Fahrenheit to about 300 degrees Fahrenheit, or both. The filtration system 400 may be well suited for use in a laboratory setting. For example, the filtration system 400 may be a high pressure high temperature (HPHT) permeability depletion test apparatus.

The filtration system 400 includes, among other components, at least one filter assembly 405. For example, in the illustrated embodiment, the filtration system 400 includes three filter assemblies 405. Each of the filter assemblies 405 may include: a filter holder base having an aperture extending therethrough and a cavity formed at a first end thereof; a backing disposed in the cavity of the filter holder base; a filter membrane positioned over the backing; a seal assembly coupled to the filter holder base and sealingly engaging a surface of the filter membrane; a cover having an aperture extending therethrough and disposed over the seal assembly and at least a portion of the filter holder base, wherein the cover is secured to the filter holder base to substantially close the cavity. These various components that make up the filter assembly 405 and their structural and functional relationship to each other are described in detail above with reference to FIGS. 1A-3C. The filter assembly 405 may be installed in-line with high pressure equipment of the filtration system 400.

The filtration system 400 may also include a first conduit 410 for providing fluid to the filter assembly 405 and a first coupling element 415 fluidly coupling the first conduit 410 to the aperture (e.g., 320 of FIG. 3C) of the cover 300 proximate an upper end of the filter holder base (e.g., 100 of FIG. 1A). Thus, the filter assembly 405 is coupled to the first conduit 410 via the first coupling element 415. In addition, the filtration system 400 may include a second conduit 420 for receiving filtered fluid from the filter assembly 405 and a second coupling element 430 coupling the second conduit 420 to the aperture (e.g., 150 of FIG. 1E) at a lower end of the filter holder base (100). Thus, the filter assembly 405 is coupled to the second conduit 420 via the second coupling element 430. The filtration system 400 may also include one or more pumps, one or more valves, additional conduits, additional filter assemblies 405 as shown, one or more sensors/gauges, etc.

Conduits may vary in material make up/composition, length, inner diameter, outer diameter, strength, etc. For example, the conduits 410 and 420 illustrated in FIG. 4 may include ¼″ diameter tubing made of a material such as stainless steel or Hastelloy C276. Practically any conduit capable of coupling with the filter assembly 405 and supporting a flow of high pressure fluid therethrough may be utilized.

Coupling elements may vary in material make up/composition, length, inner diameter, outer diameter, strength, etc. For example, the coupling elements 415 and 430 illustrated in FIG. 4 may include HF4 style fittings made of a metal material such as stainless steel or Hastelloy C276. Practically any coupling element capable of coupling the filter assembly 405 to a conduit and supporting a flow of high pressure fluid therethrough may be utilized.

Turning to the filter assembly 405 illustrated in the center of FIG. 4, in operation, a fluid flows through the first conduit 410 into the inlet (325) of the filter holder cover 300. Next, the fluid flows through the filter assembly 405, including flowing through the filter membrane (196) and then through the backing (195), which are maintained in place by the seal assembly (200). Next, the fluid exits the filter assembly 405 through the outlet (152) of the filter holder base (100) and flows into the second conduit 420. The fluid flows through the second conduit 420 to another destination, such as another destination within the filtration system 400.

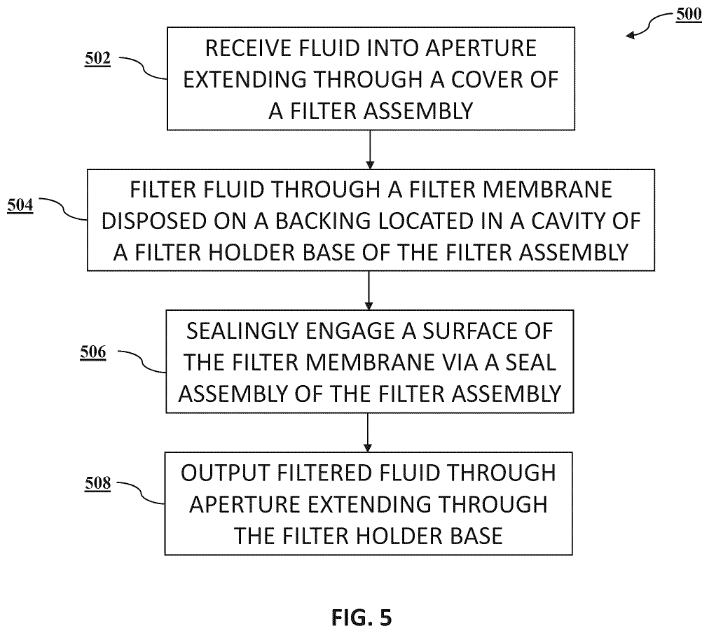

FIG. 5 illustrates an exemplary method 500 of filtering a fluid, in accordance with the present disclosure. At block 502, the method 500 includes receiving a fluid into an aperture (320) extending through a cover (300) of a filter assembly (405). The method 500 may include receiving the fluid at a fluid pressure within a range of about 1 psi to about 30,000 psi, at a fluid temperature within a range of about 60 degrees Fahrenheit to about 300 degrees Fahrenheit, or both. At block 504, the method 500 includes filtering the fluid through a filter membrane (196) disposed on a backing (195) located within a cavity (102) of a filter holder base (100) of the filter assembly (405). Filtering the fluid may involve, for example, directing the fluid through the filter membrane (196), through the backing (195), and through a funnel shaped portion (145) of the cavity into an aperture (150) extending through the filter holder base (100). At block 506, the method 500 includes sealingly engaging a surface of the filter membrane (196) via a seal assembly (200) of the filter assembly (405). As discussed above, the cover (300) is disposed over the seal assembly (200) and at least a portion of the filter holder base (100), and the cover (300) is secured to the filter holder base (100) to substantially close the cavity (102). At block 508, the method 500 includes outputting the filtered fluid through the aperture (150) extending through the filter holder base (100).

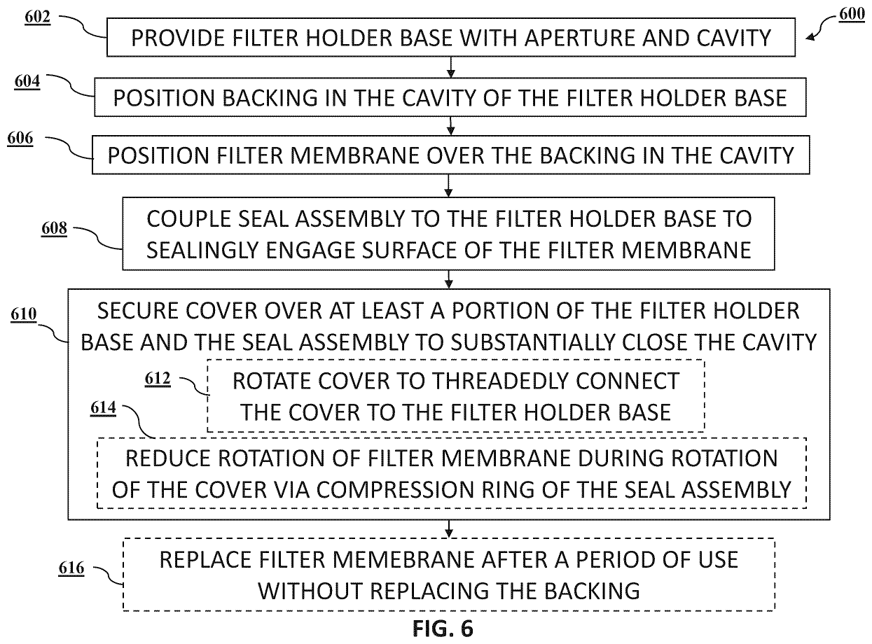

FIG. 6 illustrates an exemplary method 600 of manufacturing a filtration system, in accordance with the present disclosure. At block 602, the method 600 includes providing a filter holder base (100) having an aperture (150) extending therethrough and a cavity (102) formed at a first end (104) of the filter holder base. At block 604, the method 600 includes positioning a backing (195) in the cavity (102) of the filter holder base (100). At block 606, the method 600 includes positioning a filter membrane (196) over the backing (195) in the cavity (102). At block 608, the method 600 includes coupling a seal assembly (200) to the filter holder base (100) such that the seal assembly (200) sealingly engages a surface of the filter membrane (196). At block 610, the method 600 includes securing a cover (300) over at least a portion of the filter holder base (100) and the seal assembly (200) to substantially close the cavity (102). Securing the cover (300) may involve, at block 612, rotating the cover (300) with respect to the filter holder base (100) to threadedly connect the cover (300) to the filter holder base (100) and, at block 614, reducing rotation of the filter membrane (196) during rotation of the cover (300) via a compression ring (205) of the seal assembly (200). At block 616, the method 600 may include replacing the filter membrane (196) after a period of use without also replacing the backing (195). Since the less expensive filter membrane (196), not the backing (195) is being used to filter the fluid, filter replacement costs can be reduced or minimized during operation of the filtration system.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A filtration system to filter a fluid, the filtration system comprising:
a filter assembly comprising:
a filter holder base having an aperture extending therethrough and a cavity formed at a first end thereof;
a backing disposed in the cavity of the filter holder base;
a filter membrane positioned over the backing;
a seal assembly coupled to the filter holder base and sealingly engaging a surface of the filter membrane; and
a cover having an aperture extending therethrough and disposed over the seal assembly and at least a portion of the filter holder base, wherein the cover is secured to the filter holder base to substantially close the cavity.

2. The filtration system of claim 1, wherein the seal assembly comprises an O-ring to sealingly engage the surface of the filter membrane.

3. The filtration system of claim 2, wherein the seal assembly further comprises an O-ring compression ring shaped to form an interlocking interface with the filter holder base.

4. The filtration system of claim 3, wherein the O-ring compression ring comprises one or more projections configured to be received into one or more grooves at the first end of the filter holder base to reduce rotation of the O-ring with respect to the filter holder base.

5. The filtration system of claim 1, wherein at least a portion of the cavity is defined by a stepped profile along an inner diameter of the filter holder base, wherein the backing is supported by a first surface of the stepped profile, and wherein the filter membrane is supported by a second surface of the stepped profile.

6. The filtration system of claim 5, wherein the filter membrane is disposed between the second surface of the stepped profile on one side of the filter membrane and the seal assembly on an opposite side of the filter membrane.

7. The filtration system of claim 1, wherein the filtration system is capable of filtering the fluid at a fluid pressure within a range of about 1 psi to about 30,000 psi, at a fluid temperature within a range of about 60 degrees Fahrenheit to about 300 degrees Fahrenheit, or both.

8. The filtration system of claim 1, wherein the filter membrane is a cellulose acetate filter membrane, silver membrane, ceramic membrane or glass fiber filter.

9. The filtration system of claim 1, wherein the filter membrane is disk shaped and is from about 40 mm to about 150 mm in diameter.

10. The filtration system of claim 1, wherein the backing is a disk shaped metal frit.

11. The filtration system of claim 5, wherein the backing is from about 25 mm to about 135 mm in diameter.

12. The filtration system of claim 1, further comprising:
a first conduit for providing the fluid to the filter assembly;
a first coupling element coupling the first conduit to the aperture of the cover proximate the first end of the filter holder base;
a second conduit for receiving filtered fluid from the filter assembly; and
a second coupling element coupling the second conduit to the aperture of the filter holder base at a second end of the filter holder base opposite the first end.

13. A filter holder, comprising:
a filter holder base having an aperture extending therethrough and a cavity formed at a first end thereof, wherein the filter holder base is shaped to receive and support a backing on a first surface thereof and to receive and support a filter membrane on a second surface thereof;
a seal assembly configured to be coupled to the filter holder base and to sealingly engage a surface of the filter membrane when the filter membrane is on the second surface of the filter holder base; and
a cover having an aperture formed therethrough and configured to be disposed over the seal assembly and over at least a portion of the filter holder base and secured to the filter holder base to substantially close the cavity.

14. The filter holder of claim 13, wherein the seal assembly further comprises:
an O-ring to sealingly engage the surface of the filter membrane; and
an O-ring compression ring shaped to form an interlocking interface with the filter holder base.

15. A method of filtering a fluid, the method comprising:
receiving a fluid into an aperture extending through a cover of a filter holder;
filtering the fluid through a filter membrane disposed on a backing located within a cavity of a filter holder base;
sealingly engaging a surface of the filter membrane via a seal assembly of the filter holder, wherein the cover is disposed over the seal assembly and at least a portion of the filter holder base, and wherein the cover is secured to the filter holder base to substantially close the cavity; and
outputting the filtered fluid through an aperture extending through the filter holder base.

16. The method of claim 15, further comprising receiving the fluid at a fluid pressure within a range of about 1 psi to about 30,000 psi, at a fluid temperature within a range of about 60 degrees Fahrenheit to about 300 degrees Fahrenheit, or both.

17. The method of claim 15, further comprising directing the fluid through the filter membrane, through the backing, and through a funnel shaped portion of the cavity into the aperture extending through the filter holder base.

18. A method of manufacturing a filtration system, comprising:
providing a filter holder base having an aperture extending therethrough and a cavity formed at a first end thereof;
positioning a backing in the cavity of the filter holder base;
positioning a filter membrane over the backing in the cavity;
coupling a seal assembly to the filter holder base such that the seal assembly sealingly engages a surface of the filter membrane; and
securing a cover over at least a portion of the filter holder base and the seal assembly to substantially close the cavity.

19. The method of claim 18, further comprising:
securing the cover by rotating the cover with respect to the filter holder base to threadedly connect the cover to the filter holder base; and
reducing rotation of the filter membrane during rotation of the cover via a compression ring of the seal assembly.

20. The method of claim 18, further comprising replacing the filter membrane after a period of use without also replacing the backing.
